(19) United States
(12) Patent Application Publication
(10) Pub. No.: US 2008/0025415 A1
(43) Pub. Date: Jan. 31, 2008

(54) Uplink Coding And Multiplexing Instrumentation

(76) Inventor: Ari Hatula, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/660,200

(22) PCT Filed:
(86) PCT No.: PCT/IB04/02748

(51) Int. Cl. H04B 14/04

(52) U.S. Cl. 375/242; 714/756

(57) ABSTRACT

This invention describes a method for a new methodology for uplink encoding (coding and multiplexing) of data from multiple transport channels without intermediate memories using “on the fly” method. This invention presents a new encoding architecture for implementing “transport channel multiplexing structure for uplink” per 3GPP TS 25.212 V6.2.0 (2004-06). The present invention decreases the memories by simultaneously running encoding steps of channel coding (14), first interleaving (16), rate matching (28), second interleaving and multiplexing (18). This memory reduction is accomplished by a “handshaking” between the appropriate blocks. The invention creates opportunities for designing application specific integrated circuits (ASICs) to implement the above standards in terms of reducing complexity, chip area, power consumption and a number of interrupt commands for processing, which consequently decreases digital signal processing (DSP) requirements.

### TECHNICAL FIELD

This invention generally relates to audio and data coding and more specifically to uplink encoding (coding and multiplexing) of data from multiple transport channels without intermediate memories.

### BACKGROUND ART

An uplink encoding (coding and multiplexing) technology for implementing a “transport channel multiplexing structure for uplink” is described in 3GPP TS 25.212 V6.2.0 (2004-06), see page 11, as well as in earlier versions of this document. The algorithm is rather demanding. In practice it requires to use several intermediate memories (with buffers) to perform, e.g., a first interleaving or a second interleaving. This creates some difficulties for designing application specific integrated circuits (ASIC) to implement the above standards in terms of reducing complexity, chip area, power consumption and a number of interrupt commandS for processing, which consequently increases digital signal processing (DSP) requirements. It is highly desirable to minimize a number of memories to be used for implementing the uplink encoding and multiplexing algorithm described in the 3GPP standard quoted above. This problem is addressed by the present invention.

### DISCLOSURE OF THE INVENTION

The object of the present invention is to provide a methodology for uplink encoding (coding and multiplexing) of data from multiple transport channels without intermediate memories using “on the fly” method.

According to a first aspect of the invention, a method for uplink coding and multiplexing of data from N transport channels comprises the steps of: coding the data from a transport channel out of N transport channels, wherein N is an integer of at least a value of one; interleaving the coded data; performing rate matching of the interleaved data; and further interleaving and multiplexing the rate matched data with further rate matched data from further transport channels out of the N transport channels, thus providing the uplink coding and multiplexing of the data from the N transport channels, wherein no intermediate memories are used for the uplink coding and multiplexing.

According further to the first aspect of the invention, before the step of coding, the method may comprise the step of: choosing a type of channel coding to be used for coding the data from the N transport channels optionally based on a spectral content of the data; wherein the step of coding is performed using the chosen type of channel coding. Further, the type of the channel may have a convolutional coding algorithm or a turbo coding algorithm. Still further, the coding may be provided by a T-coder block if the turbo coding algorithm is chosen or may be provided by a C-coder block if the convolutional coding algorithm is chosen, thus providing a T-coded signal or a C-coded signal, respectively. Yet still further, the coding and interleaving may be provided by a T-coder and interleaver block if the turbo coding algorithm is chosen or may be provided by a C-coder interleaver block if the convolutional coding algorithm is chosen, thus providing a T-coded and interleaved signal or a C-coded and interleaved signal, respectively.

Further according to the first aspect of the invention, the coding may be provided by a coder block, thus providing a coded signal. Further, the interleaving of the coded data may be performed by an interleaver block using the coded signal. Still further, the coded signal may be provided by the coder block to the interleaver block only after the interleaver block provides a data request signal to the coder block and the coder block provides a data ready signal to the interleaver block, thus eliminating a need for the intermediate memory. Yet still further, after completing the interleaving of the coded data, the interleaver block may provide a rate matched signal containing the interleaved and coded data after optionally modifying it by performing a radio frame equalization (RFE), a radio frame segmentation (RFS) and a rate matching (RM). Yet further still, the rate matched signal may be provided by the interleaver block to a further interleaver block for performing the further interleaving and multiplexing only after the interleaver block provides a rate matching ready signal to the further interleaver block, thus eliminating a further need for the intermediate memory.

Still further according to the first aspect of the invention, the coding and interleaving may be provided by a coder and interleaver block, thus providing a coded and interleaved signal. Further, after completing the interleaving of the coded data, the coder and interleaver block may provide to a rate matching block the coded and interleaved signal containing the interleaved and coded data optionally modified by performing a radio frame equalization (RFE) and a radio frame segmentation (RFS). Still further, the coded and interleaved signal may be provided by the coder and interleaver block to the rate matching block only after the rate matching block provides a data request signal to the coder and interleaver block and the coder and interleaver block may provide a data ready signal to the rate matching block, thus eliminating a need for the intermediate memory. Yet still further, the rate matched signal may be provided by the rate matching block in response to the coded and interleaved signal to a further interleaver block for performing the further interleaving and multiplexing only after the rate matching block provides a rate matching ready signal to the further interleaver block, thus eliminating a further need for the intermediate memory.

According further to the first aspect of the invention, the further interleaving and multiplexing may be performed by a further interleaver block by writing the rate matched data indicated by a rate matched signal directly to a further memory, thus eliminating a need for the intermediate memory, wherein optionally the further memory may be a further random access memory. Further, after finishing the further interleaving and multiplexing of the rate matched signal representing the data from the transport channel out of the N transport channels, the further interleaver block may provide a transport channel multiplexing complete signal indicating that the further interleaving and multiplexing is completed for the data from the transport channel. Still further, in response to the transport channel multiplexing complete signal, further data from a further transport channel out of the N transport channels may be provided to a coder block or to a coder and interleaver block by a memory for further multiplexing with the data from the transport channel, wherein optionally the memory may be a random access memory.

According still further to the first aspect of the invention, the data from any transport channel of the N transport may be provided for the coding by a memory, wherein optionally the memory may be a random access memory.

According to a second aspect of the invention, a computer program product comprising a computer program code characterized in that it includes instructions for an uplink coding and multiplexing of data from N transport channels, comprises the steps of: coding the data from a transport channel out of N transport channels, wherein N is an integer of at least a value of one; interleaving the coded data; performing rate matching of the interleaved data; and further interleaving and multiplexing the rate matched data with further rate matched data from further transport channels out of the N transport channels, thus providing the uplink coding and multiplexing of the data from the N transport channels, wherein no intermediate memories are used for the uplink coding and multiplexing.

According to a third aspect of the invention, an electronic device capable of uplink coding and multiplexing of data from N transport channels comprises: means for coding the data from a transport channel out of the N transport channels, wherein N is an integer of at least a value of one; means for interleaving the coded data; means for rate matching of the interleaved data; a further interleaver block, for further interleaving and multiplexing the rate matched data with further rate matched data from further transport channels of the N transport channels; and a further memory, for direct writing the further interleaved and multiplexed data, thus providing the uplink coding and multiplexing of the data from the N transport channels, wherein no intermediate memories are used for the uplink coding and multiplexing and wherein optionally the further memory is a further random access memory.

According further to the third aspect of the invention, the electronic device may further comprise a memory, for providing the data from any transport channel of the multiple transport channels for the coding by the coding means, wherein optionally the memory may be a random access memory.

Further according to the third aspect of the invention, the electronic device may further comprises a processor, for setting controls of the means for the coding, of the means for the interleaving, of the means for the rate matching and of the further interleaver block.

Still further according to the third aspect of the invention, a type of channel coding to be used for coding the data from the N transport channels may be chosen and may be optionally based on a spectral content of the data. Further, the type of the channel coding may have a convolutional coding algorithm or a turbo coding algorithm. Still further, the means for coding may be a T-coder block if the turbo coding algorithm is chosen or a C-coder block if the convolutional coding algorithm is chosen, for providing a T-coded signal or a C-coded signal, respectively. Yet further still, the means for the coding and means for the interleaving may be combined in a T-coder and interleaver block if the turbo coding algorithm is chosen or may be combined in a C-coder and interleaver block if the convolutional coding algorithm is chosen, for providing a T-coded and interleaved signal or a C-coded and interleaved signal, respectively.

According further to the third aspect of the invention, the means for coding may be a coder block, for providing a coded signal. Further, the interleaving of the coded data may be performed by an interleaver block using the coded signal. Further, the coded signal may be provided by the coder block to the interleaver block only after the interleaver block provides a data request signal to the coder block and the coder block may provide a data ready signal to the interleaver block, thus eliminating a need for the intermediate memory. Still further, after completing the interleaving of the coded data, the interleaver block may provide a rate matched signal containing the interleaved and coded data after optionally modifying it by performing a radio frame equalization (RFE), a radio frame segmentation (RFS) and a rate matching (RM). Yet further still, the rate matched signal may be provided by the interleaver block to the further interleaver block for performing the further interleaving and multiplexing only after the interleaver block provides a rate matching ready signal to the further interleaver block, thus eliminating a further need for the intermediate memory.

According still further to the third aspect of the invention, the means for coding and means for interleaving may be combined in a coder and interleaver block, for providing a coded and interleaved signal. Further, after completing the interleaving of the coded data, the coder and interleaver block provides the coded and interleaved signal containing the interleaved and coded data optionally modified by performing a radio frame equalization (RFE) and a radio frame segmentation (RFS). Still further, the coded and interleaved signal may be provided by the coder and interleaver block to the rate matching block only after the rate matching block provides a data request signal to the coder and interleaver block and the coder and interleaver block provides a data ready signal to the rate matching block, thus eliminating a need for the intermediate memory. Yet still further, the means for the rate matching may be a rate matching block, responsive to the coded and interleaved signal, for providing a rate matched signal to a further interleaver block for performing the further interleaving and the multiplexing only after the rate matching block provides a rate matching ready signal to the further interleaver block, thus eliminating a further need for the intermediate memory.

According yet further still to the third aspect of the invention, the further interleaving and multiplexing may be performed by the further interleaver block by writing the rate matched data indicated by a rate matched signal directly to the further memory, thus eliminating a need for the intermediate memory, wherein optionally the further memory is a further random access memory. Further, after finishing the further interleaving and multiplexing of the rate matched signal representing the data from the transport channel out of the N transport channels, the further interleaver block may provide a transport channel multiplexing complete signal. Still further, in response to the transport channel multiplexing complete signal, further data from another transport channel out of the N transport channels may be provided to the means for coding by a memory for further multiplexing with the data from the transport channel, wherein optionally the memory may be a random access memory.

According further still to the third aspect of the invention, the electronic device may be an electronic communication device, a mobile terminal, a mobile communication device or a mobile phone.

Yet still further according to the third aspect of the invention, an integrated circuit may be used for incorporating the means for coding, the means for interleaving, the means for rate matching, the further interleaver block and a further memory.

According to a fourth aspect of the invention, an integrated circuit capable of uplink coding and multiplexing of data from N transport channels comprises:

means for coding the data from a transport channel out of the N transport channels, wherein N is an integer of at least a value of one;

means for interleaving the coded data;

means for rate matching of the interleaved data;

a further interleaver block, for further interleaving and multiplexing the rate matched data with further rate matched data from further transport channels of the N transport channels; and

a further memory, for direct writing the further interleaved and multiplexed data, thus providing the uplink coding and multiplexing of the data from the N transport channels, wherein no intermediate memories are used for the uplink coding and multiplexing and wherein optionally the further memory is a further random access memory.

According further to the fourth aspect of the invention, the integrated circuit may further comprise a memory, for providing the data from any transport channel of the N transport channels for the coding by the coding means, wherein optionally the memory is a random access memory.

Further according to the fourth aspect of the invention, the integrated circuit may further comprises a processor, for setting controls of the means for coding, of the means for the interleaving, of the means for the rate matching and of the further interleaver block.

### BRIEF DESCRIPTION OF THE DRAWINGS

For a better understanding of the nature and objects of the present invention, reference is made to the following detailed description taken in conjunction with the following drawings, in which:

FIG. 1 shows a standard to be complied with by the present invention for transport channel multiplexing structure for uplink, according to 3GPP TS 25.212 V6.2.0 (2004-03);

FIG. 2 shows a block diagram of an encoding architecture for uplink coding and multiplexing of data from multiple transport channels, according to the present invention;

FIG. 3 shows a block diagram of an alternative implementation of encoding for uplink coding and multiplexing of FIG. 2, according to the present invention;

FIG. 4 shows a block diagram of an alternative implementation of an encoding architecture for a fast processing path of uplink coding and multiplexing of FIG. 2, according to the present invention;

FIG. 5 shows a block diagram of an alternative implementation of encoding for uplink coding and multiplexing of FIG. 4, according to the present invention;

FIG. 6 shows a flow chart for uplink coding and multiplexing shown in FIGS. 3 and 2, according to the present invention; and

FIG. 7 shows a flow chart for uplink coding and multiplexing shown in FIG. 5, according to the present invention.

### BEST MODE FOR CARRYING OUT THE INVENTION

The present invention provides a new methodology for uplink encoding (coding and multiplexing) of data from multiple transport channels without intermediate memories using “on the fly” method.

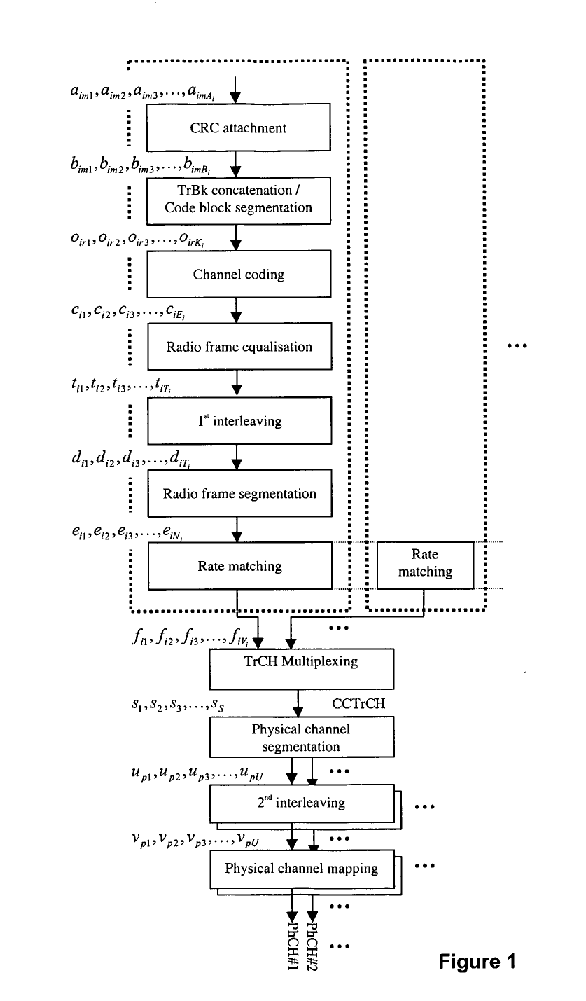

The invention presents a new encoding architecture for implementing a “transport channel multiplexing structure for uplink” shown in FIG. 1 per 3GPP TS 25.212 V6.2.0 (2004-06). Specifically, the present invention decreases the memories by simultaneousLY running encoding steps of channel coding, first interleaving, rate matching, second interleaving and multiplexing. This is accomplished by a “handshaking” between the appropriate blocks as discussed in detail below.

The present invention makes the implementation of uplink encoding easier by decreases the memories to be used in the implementation of the algorithm. This creates new opportunities for designing application specific integrated circuits (ASIC) to implement the above standards in terms of reducing complexity, power consumption and a number of interrupt commands for processing, which consequently decreases digital signal processing (DSP) requirements.

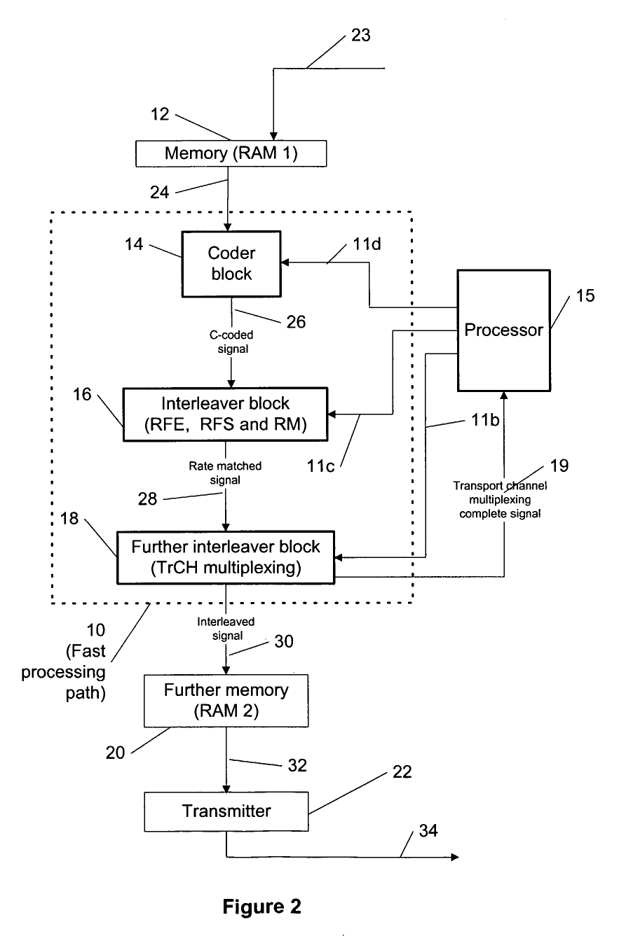

FIG. 2 shows one example among others of a block diagram of an encoding architecture for uplink coding and multiplexing of data from multiple transport channels, according to the present invention.

Data from N (N is an integer of at least a value of one) transport channels is provided to (using a data bus 23) and stored in a memory 12. This data from the N transport channels, according to the present invention, contains CRC (cyclic redundancy check) attachment, TrBr concatenation/code block segmentation as required by the 3GPP standard shown in Figure. The memory 12 can be a random access memory. The encoding (coding and multiplexing) process is started and controlled (e.g., indicating when the next transport channel is started, controlling the rate matching parameter calculation, etc.) by providing a transport channel control signals 11b, 11c and 11d to the blocks 14, 16 and 18 (their performance is described below) by the processor 15. In response to the signal 11d a coder block 14 reads the data from the memory 12 (a signal 24) for one transport channel out of said N transport channels. After coding (details on coding are provided below) by the coder block 14, the coded data from said one transport channel (a coded signal 26) is provided to an interleaver block 16.

In a conventional processing an additional memory block (buffer) is normally used to facilitate an interleaving operation of the block 16. According to the present invention that is not necessary. Instead of using the additional memory block a “handshaking” procedure between the blocks 14 and 16 is used, allowing to perform the interleaving procedure “on the fly”. For example, the coded signal 26 is provided by said coder block 14 to said interleaver block 16 only after said interleaver block 16 provides a data request signal (e.g., setting “DataRequest” signal to “high”) to said coder block 14 and said coder block 14 provides a data ready signal (e.g., setting “DataReady” signal to “high”) to said interleaver block 16. This signaling, “DataRequest” to “DataReady”, is continuing until all data bits have been interleaved by the block 16. Thus the “handshaking” procedure eliminates a need for said intermediate memory.

After completing the interleaving of said coded data, the interleaver block 16 also performs a radio frame equalization (RFE), a radio frame segmentation (RFS) and a rate matching (RM) as required by the 3GPP standard shown in FIG. 1. Thus, a rate matched signal 28 containing said interleaved and coded data is provided by the interleaver block 16 to a further interleaver block 18 for performing further interleaving and multiplexing. However, according to the present invention, the rate matched signal 28 is provided to the further interleaver block 18 only after said interleaver block 16 provides a rate matching ready signal (e.g., setting “RateMatchingRdy” signal to “high”) to said further interleaver block 18, thus eliminating a further need for said intermediate memory. The further interleaving and multiplexing is performed by the further interleaver block 18 by writing (as an interleaved signal 30 in FIG. 2) said rate matched data contained in the rate matched signal 28 directly to a further memory 20. The further memory 20 can be, e.g., a further random access memory.

After finishing the further interleaving and multiplexing of said data from said one transport channel out of the N transport channels, the further interleaver block 18 provides to the processor 15 a transport channel multiplexing complete signal 19 indicating that said further interleaving and multiplexing is completed for said data from said one transport channel. In response to said transport channel multiplexing complete signal 19, the processor signals (by sending the transport channel control signals 11b, 11c and 11d mentioned above) to the blocks 14, 16 and 18 to provide further data from a further transport channel out of said N transport channels to a coder block 14.

The procedure described above is repeated until all the data from all said N transport channels is multiplexed in the further memory 12. The coded and multiplexed data from said N transport channels stored in the further memory 20 (acting as a buffer) is provided as an input transport signal (signal 32) to a transmitter 22 for sending to a network (signal 34). During the processing described above, the processor 15 sets the controls of all blocks (the blocks 14, 16 and 18) of a fast processing path 10.

The transmitter 22 reads the interleaved data (signal 32) via an interface buffer (e.g., the further memory 20) for further processing. It is noted that the interface buffer size depends on a processing clock frequency: for higher frequencies registers can be used as the further memory 20, however for lower frequencies a small RAM can be used as the further memory 20.

According to the present invention, an electronic device capable of uplink coding and multiplexing of data from N transport channels described above and shown in FIG. 2 can be an electronic communication device, a mobile terminal, a mobile communication device or a mobile phone.

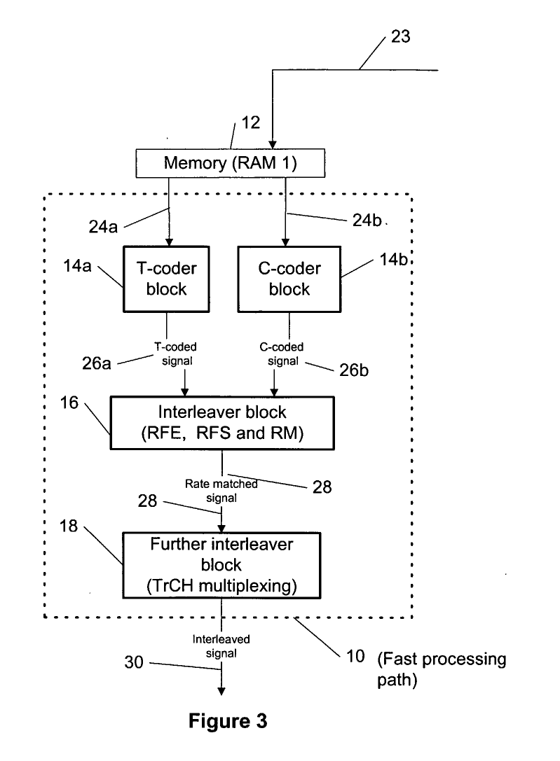

Also, the new encoding architecture described in this invention creates opportunities for designing application specific integrated circuits (ASICs) to implement the 3GPP standards, quoted above, in terms of reducing complexity and chip area, power consumption and a number of interrupt commands for processing, which consequently decreases digital signal processing (DSP) requirements and the chip area. Such integrated circuit can contain all or selected components (blocks) shown in FIG. 2, as well as in FIGS. 3, 4 and 5 discussed below.

FIG. 3 shows another example among others of an alternative implementation of the fast processing path 10 of encoding for the uplink coding and multiplexing of FIG. 2, according to the present invention. Here, a type of channel coding to be used for coding the data from said N transport channels can be chosen, e.g., based on a spectral content of said data. The type of the channel coding, according to a preferred embodiment of the present invention, can have a convolutional coding algorithm or a turbo coding algorithm. Thus, as shown in FIG. 3, the coding can be provided by a T-coder block 14a if said turbo coding algorithm is chosen or it can be provided by a C-coder block 14b if said convolutional coding algorithm is chosen, thus providing a T-coded signal 26a or a C-coded signal 26b, respectively. Each of the signals 26a or 26b is equivalent to the coded signal 26 of FIG. 2. The rest of the processing is the same as described in regard to FIG. 2.

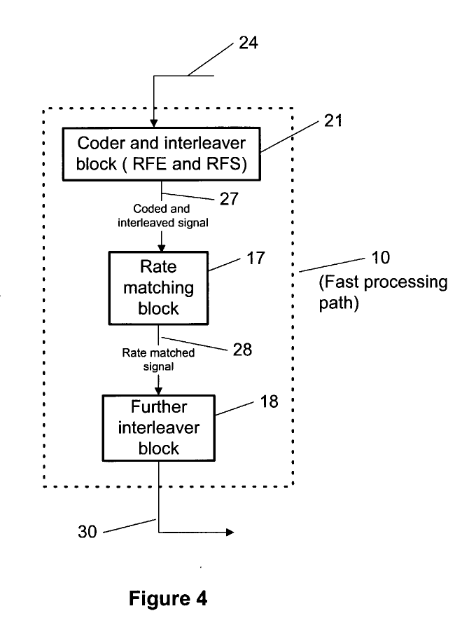

FIG. 4 shows yet another example among others of an alternative implementation of the fast processing path 10 of encoding for the uplink coding and multiplexing of FIG. 2, according to the present invention.

The difference of FIG. 4 from FIG. 2 is that the coding and interleaving (e.g., a virtual interleaving) are provided by a coder and interleaver block 21 (instead of using two separate blocks 14 and 16 in FIG. 2), thus providing a coded and interleaved signal 27 to a rate matching block 17. After completing the interleaving of said coded data, the coder and interleaver block 21 also typically performs a radio frame equalization (RFE) and a radio frame segmentation (RFS) as required by the 3GPP standard shown in FIG. 1.

In a conventional processing an additional memory block (buffer) would be normally required to facilitate a rate matching operation of the rate matching block 17. According to the present invention that is not necessary (similarly to the procedure described in regard to FIG. 2). Instead of using the additional memory block a “handshaking” procedure between the blocks 21 and 18 is used allowing to perform the rate matching procedure “on the fly”. For example, the coded and interleaved signal 27 is provided by said coder and interleaver block 21 to said rate matching block 17 only after said rate matching block 17 provides a data request signal (e.g., setting “DataRequest” signal to “high”) to said coder and interleaver block 21 and said coder and interleaver block 21 provides a data ready signal (e.g., setting “DataReady” signal to “high”) to said rate matching block 17. Again, this signaling, “DataRequest” to “DataReady”, is continuing until all data bits have been interleaved by the block 17. Thus the “handshaking” procedure eliminates a need for said intermediate memory, as mentioned above.

Similarly to FIG. 2, a rate matched signal 28 of FIG. 4 containing said interleaved and coded data is provided by the rate matching block 17 to a further interleaver block 18 for performing said further interleaving and multiplexing. Again, according to the present invention, the rate matched signal 28 is provided to a further interleaver block 18 only after said rate matching block 17 provides a rate matching ready signal (e.g., setting “RateMatchingRdy” signal to “high”) to said a further interleaver block 18, thus eliminating a further need for said intermediate memory. The rest of the processing is the same as described in regard to FIG. 2.

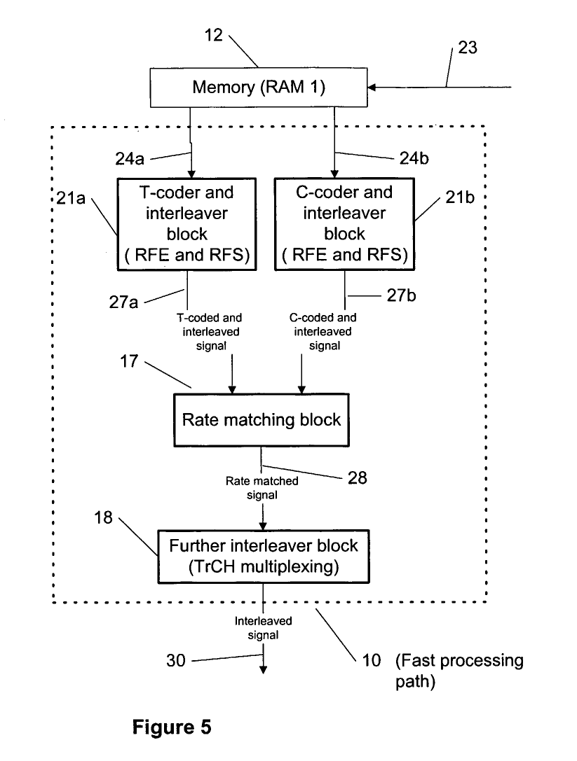

FIG. 5 shows a further example among others of an alternative implementation of the fast processing path 10 of encoding for the uplink coding and multiplexing of FIG. 4, according to the present invention. Here, similar to FIG. 3, a type of channel coding to be used for coding the data from said N transport channels can be chosen, e.g., based on the spectral content of said data. The type of the channel coding, according to the present invention, can have the convolutional coding algorithm or the turbo coding algorithm. Thus, as shown in FIG. 5, the coding can be provided by a T-coder and interleaver block 21a if said turbo coding algorithm is chosen or can be provided by a C-coder and interleaver block 21b if said convolutional coding algorithm is chosen, thus providing a T-coded and interleaved signal 27a or a C-coded interleaved signal 27b, respectively. Each of the signals 27a or 27b is equivalent to the coded and interleaved signal 27 of FIG. 4. The rest of the processing is the same as described in regard to FIGS. 4 and 2.

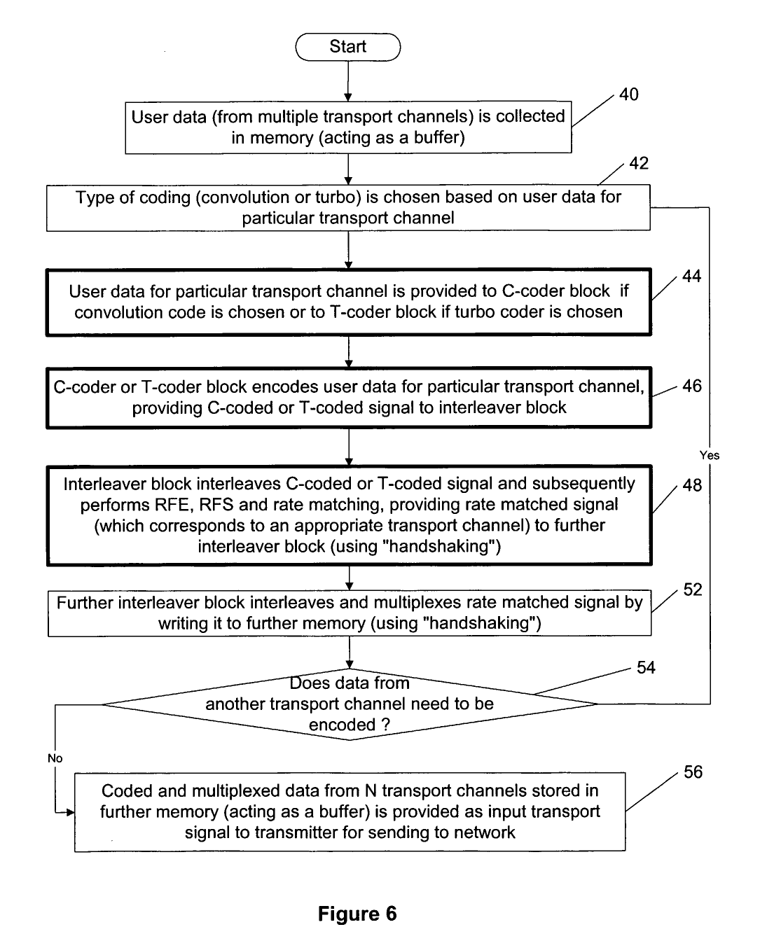

FIG. 6 shows a flow chart for the uplink coding and multiplexing shown in FIGS. 3 and 2, according to the present invention

The flow chart of FIG. 6 represents only one possible scenario among many others. In a method according to the present invention, in a first step 40, the user data (from the N transport channels) is collected in the memory 12 (acting as a buffer). In a next step 42, the type of coding (convolution or turbo) is chosen based on the user data for the particular one transport channel. In a next step 44, the user data for the particular one transport channel is provided to the C-coder block 14b if the convolution code is chosen or to the T-coder block 14a if the turbo coder is chosen. In a next step 46, the C-coder 24b or the T-coder block 24a encodes the user data for the one particular transport channel, providing the C-coded or T-coded signal 26b or 26a, respectively, to the interleaver block 16. In a next step 48, the interleaver block 16 interleaves the C-coded or T-coded signal and subsequently performs the RFE, the RFS and the rate matching, providing the rate matched signal 28 (which corresponds to the data from the processed transport channel) to the further interleaver block 18 using the “handshaking” procedure described above.

In a next step 52, the further interleaver block 18 interleaves and multiplexes the rate matched signal 28 by the direct writing (the signal 30) it to the further memory 20 again using “handshaking” procedure described above. In a next step 54, it is determined whether further data from another transport channel out of said N transport channels needs to be encoded (coded and multiplexed). If that is the case, the process goes back to step 42 and repeats the same steps again with the further data from another transport channel. However, if it is determined that there is no further data out of said N transport channels needed to be encoded, in a next step 56, the coded and multiplexed data from N transport channels stored in further memory 20 (acting as a buffer) is provided to the transmitter 22 for sending to the network (signal 34).

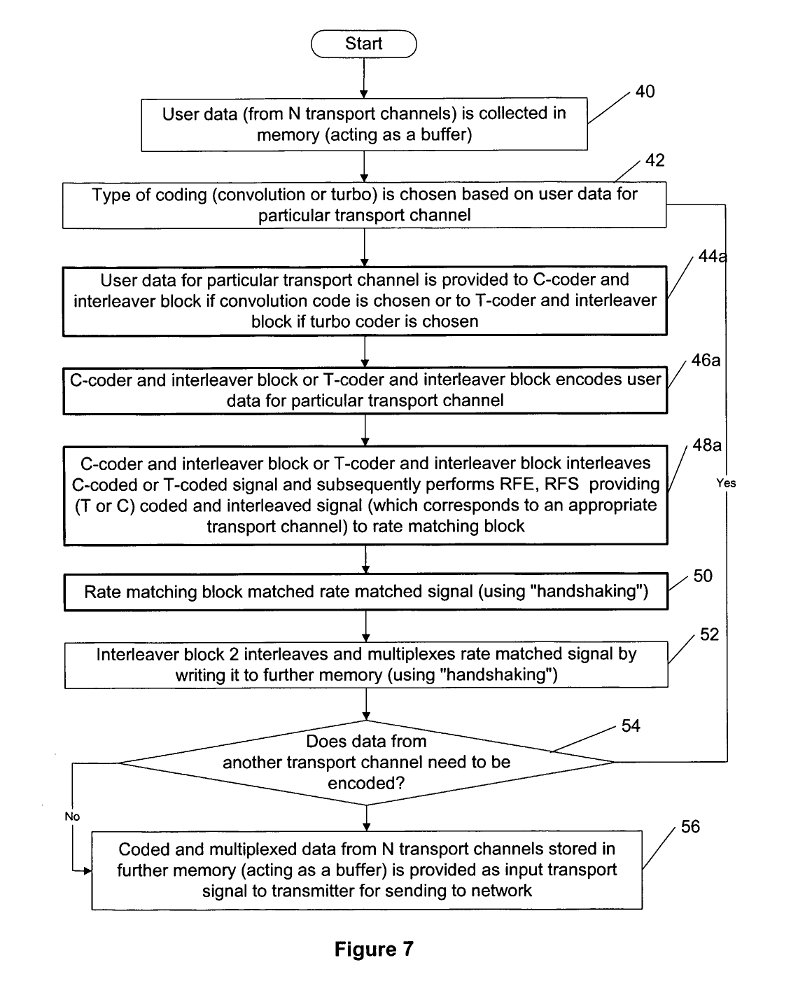

FIG. 7 shows a flow chart for the uplink coding and multiplexing shown in FIG. 5, according to the present invention. The flow chart of FIG. 7 represents only one possible scenario among many others. The procedure is similar to the one described in FIG. 6 but with steps 44, 46 and 48 substituted by step 44a, 46a, 48a and 50 which are described below.

In a method according to the present invention, in a step 44a (following the step 42 described above in regard to FIG. 6), the user data for the particular one transport channel is provided to the C-coder and interleaver block 21b if the convolution code is chosen or to the T-coder and interleaver block 21a if the turbo coder is chosen. In a next step 46a, the C-coder and interleaver block 21b or the T-coder and interleaver block 21a codes the user data for the one particular transport channel. In a next step 48a, the C-coder and interleaver block 21b or the T-coder and interleaver block 21a interleaves (using virtual interleaving) the C-coded or T-coded data and subsequently performs the RFE and the RFS providing the T- or C-coded and interleaved signal 27a or 27b to the rate matching block 17. In a next step 50, the rate matching block 17 performs rate matching thus providing the rate matched signal 28 to the further interleaver block 18 using the “handshaking” procedure described above. The rest of the processing is the same as in FIG. 6 described above.

What is claimed is:

1. A method, comprising:
coding data from a transport channel out of N transport channels for providing coded data, wherein N is an integer of at least a value of one;
interleaving said coded data for providing interleaved data;
performing rate matching of said interleaved data for providing rate matched data; and
further interleaving and multiplexing said rate matched data with further rate matched data from further transport channels out of said N transport channels for providing uplink coding and multiplexing of the data from said N transport channels, wherein no intermediate memories are required for said uplink coding and multiplexing.

2. The method of claim 1, wherein, before said coding, the method comprises:
choosing a type of channel coding for coding the data from said N transport channels based on a spectral content of said data; wherein said coding is performed using said chosen type of channel coding.

3. The method of claim 2, wherein said type of the channel coding has a convolutional coding algorithm or a turbo coding algorithm.

4. The method of claim 3, wherein a T-coder block is configured to provide a T-coded signal using said coding if said turbo coding algorithm is chosen, or a C-coder block is configured to provide a C-coded signal using said coding. if said convolutional coding algorithm is chosen.

5. The method of claim 3, wherein a T-coder interleaver block is configured to provide a T-coded and interleaved signal using said coding and said interleaving if said turbo coding algorithm is chosen or a C-coder interleaver block is configured to provide a C-coded and interleaved signal using said coding and said interleaving.

6. The method of claim 1, wherein a coder block is configured to provide a coding signal comprising said coded data.

7. The method of claim 6, wherein an interleaver block is configured to perform said interleaving of said coded data using said coded signal.

8. The method of claim 7, wherein said interleaver block is configured to provide a data request signal to said coder block and said coder block is configured to provide a data ready signal to said interleaver block followed by providing said coded signal to said interleaver block for eliminating a need for said intermediate memory.

9. The method of claim 7, wherein, after completing said interleaving of said coded data, the interleaver block is configured to provide a rate matched signal containing said interleaved data which is modified by performing a radio frame equalization, a radio frame segmentation and said rate matching.

10. The method of claim 9, wherein said interleaver block is configured to provide a rate matching ready signal to a further interleaver block and then to provide said rate matched signal to said further interleaver block for performing said further interleaving and multiplexing for eliminating a further need for said intermediate memory.

11. The method of claim 1, wherein a coder and interleaver block is configured to provide a coded and interleaved signal comprising said coding and interleaving.

12. The method of claim 11, wherein, after completing said interleaving of said coded data, said coder and interleaver block is configured to provide to a rate matching block said coded and interleaved signal containing said interleaved and coded data modified by performing a radio frame equalization and a radio frame segmentation.

13. The method of claim 12, wherein said rate matching block is configured to provide a data request signal to said coder and interleaver block and said coder and interleaver block is configured to provide a data ready signal to said rate matching block followed by providing said coded and interleaved signal to said rate matching block for eliminating a need for said intermediate memory.

14. The method of claim 12, wherein said rate matching block is configured to provide said rate matched signal in response to said coded and interleaved signal to a further interleaver block for performing said further interleaving and multiplexing for eliminating a further need for said intermediate memory.

15. The method of claim 1, wherein a further interleaver block is configured to perform said further interleaving and multiplexing by writing said rate matched data indicated by a rate matched signal directly to a further memory for eliminating a need for said intermediate memory.

16. The method of claim 15, wherein, after finishing said further interleaving and multiplexing of said rate matched signal representing said data from said transport channel out of said N transport channels, the further interleaver block is configured to provide a transport channel multiplexing complete signal indicating that said further interleaving and multiplexing is completed for said data from said transport channel.

17. The method of claim 16, wherein, in response to said transport channel multiplexing complete signal, further data from a further transport channel out of said N transport channels is provided to a coder block or to a coder and interleaver block by a memory for further multiplexing with said data from said transport channel.

18. The method of claim 1, wherein a memory is configured to provide said data from any transport channel of said N transport channels.

19. A computer program product comprising a computer program code, wherein said computer program code comprises instructions for an uplink coding and multiplexing of data, comprising:
coding said data from a transport channel out of N transport channels for providing coded data, wherein N is an integer of at least a value of one;
interleaving said coded data for providing interleaved data;
performing rate matching of said interleaved data for providing rate matched data; and
further interleaving and multiplexing said rate matched data with further rate matched data from further transport channels out of said N transport channels, thus providing said uplink coding and multiplexing of the data from said N transport channels, wherein no intermediate memories are required for said uplink coding and multiplexing.

20. An electronic device, comprising:
a coder block, configured to code data from a transport channel out of said N transport channels to provide coded data, wherein N is an integer of at least a value of one;
an interleaver block, configured to interleave said coded data and to provide interleaved data;
a rate matching block, configured to rate-match said interleaved data and to provide rate matched data;
a further interleaver block, configured to further interleave and multiplex said rate matched data with further rate matched data from further transport channels of said N transport channels; and
a further memory, configured to write directly said further interleaved and multiplexed data in order to provide uplink coding and multiplexing of the data from said N transport channels, wherein no intermediate memories are required for said uplink coding and multiplexing.

21. The electronic device of claim 20, further comprising a memory, configured to provide said data from any transport channel of said multiple transport channels for said coding by the coder block.

22. The electronic device of claim 20, further comprising a processor, configured to set controls of said coder block, of said interleaver block, of said rate matching block and of said further interleaver block.

23. The electronic device of claim 20, wherein a type of channel coding for coding the data from said N transport channels is chosen using a spectral content of said data.

24. The electronic device of claim 23, wherein said type of the channel coding has a convolutional coding algorithm or a turbo coding algorithm.

25. (canceled)

26. The electronic device of claim 24, wherein said coder block and interleaver block are combined in a T-coder and interleaver block if said turbo coding algorithm is chosen or combined in a C-coder and interleaver block if said convolutional coding algorithm is chosen, for providing a T-coded and interleaved signal or a C-coded and interleaved signal, respectively.

27. (canceled)

28. (canceled)

29. The electronic device of claim 28, wherein said coded signal is provided by said coder block to said interleaver block only after said interleaver block is configured to provide a data request signal to said coder block and said coder block is configured to provide a data ready signal to said interleaver block followed by providing a coded signal comprising said coded data to said interleaver block for eliminating a need for said intermediate memory.

30. The electronic device of claim 28, wherein, after completing said interleaving of said coded data, the interleaver block is configured to provide a rate matched signal containing said interleaved data which is modified by performing a radio frame equalization, a radio frame segmentation and said rate matching.

31. The electronic device of claim 30, wherein said interleaver block is configured to provide said a rate matching read signal to a further interleaver block and then to provide said rate matched signal to said further interleaver block for performing said further interleaving and multiplexing for eliminating a further need for said intermediate memory.

32. The electronic device of claim 20, wherein said coder block and said interleaver block are combined in a coder and interleaver block, for providing a coded and interleaved signal.

33. The electronic device of claim 32, wherein, after completing said interleaving of said coded data, said coder and interleaver block is configured to provide to a rate matching block said coded and interleaved signal containing said interleaved and coded data modified by performing a radio frame equalization and a radio frame segmentation.

34. The electronic device of claim 33, wherein said rate matching block is configured to provide a data request signal to said coder and interleaver block and said coder and interleaver block is configured to provide a data ready signal to said rate matching block followed by providing said coded and interleaved signal to said rate matching block for eliminating a need for said intermediate memory.

35. The electronic device of claim 33, wherein said rate matching block is configured to provide said rate matched signal in response to said coded and interleaved signal to a further interleaver block for performing said further interleaving and multiplexing for eliminating a further need for said intermediate memory.

36. The electronic device of claim 20, comprising a further interleaver block configured to perform said further interleaving and multiplexing by writing said rate matched data indicated by a rate matched signal directly to a further memory for eliminating a need for said intermediate memory.

37. The electronic device of claim 36, wherein, after finishing said further interleaving and multiplexing of said rate matched signal representing said data from said transport channel out of said N transport channels, the further interleaver block is configured to provide a transport channel multiplexing complete signal indicating that said further interleaving and multiplexing is completed for said data from said transport channel.

38. The electronic device of claim 37, wherein, in response to said transport channel multiplexing complete signal, further data from a further transport channel out of said N transport channels is provided to a coder block or to a coder and interleaver block by a memory for further multiplexing with said data from said transport channel.

39. (canceled)

40. The electronic device of claim 20, wherein an integrated circuit comprises said coder block, said interleaver block, said rate matching block, said further interleaver block and a further memory.

41. An integrated circuit, comprising:
a coder block, configured to code data from a transport channel out of said N transport channels to provide coded data, wherein N is an integer of at least a value of one;
an interleaver block, configured to interleave said coded data and to provide interleaved data;
a rate matching block, configured to rate-match said interleaved data and to provide rate matched data;
a further interleaver block, configured to further interleave and multiplex said rate matched data with further rate matched data from further transport channels of said N transport channels; and
a further memory, configured to write directly said further interleaved and multiplexed data in order to provide uplink coding and multiplexing of the data from said N transport channels, wherein no intermediate memories are required for said uplink coding and multiplexing.

42. The integrated circuit of claim 41, further comprising a memory, configured to provide said data from any transport channel of said N transport channels for said coding by the coder block.

43. The integrated circuit claim 41, further comprising a processor, configured to set controls of said coder block, of said interleaver block, of said rate matching block and of said further interleaver block.

44. An electronic device comprising:
means for coding data from a transport channel out of said N transport channels and providing controlled data, wherein N is an integer of at least a value of one;
means for interleaving said coded data and providing interleaved data;
means for rate matching of said interleaved data and providing rate matched data;
a further interleaver block, for further interleaving and multiplexing said rate matched data with further rate matched data from further transport channels of said N transport channels; and
a further memory, for direct writing said further interleaved and multiplexed data, thus providing uplink coding and multiplexing of the data from said N transport channels, wherein no intermediate memories are required for said uplink coding and multiplexing.

45. The electronic device of claim 44, wherein said means for coding is a T-coder block if a turbo coding algorithm is chosen or a C-coder block if a convolutional coding algorithm is chosen, for providing a T-coded signal or a C-coded signal, respectively.
